(19) United States
(12) Patent Application Publication
(10) Pub. No.: US 2006/0063488 A1
(43) Pub. Date: Mar. 23, 2006

(54) Asymmetric information transmission system using an electric near field

(75) Inventors: Gunther Hraby, Pressbaum (AT); Alexander Renner, Wien (AT); Georg Schindelarz, Wien (AT); Peter Veith, Wien (AT)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 10/530,968

(22) PCT Filed: Sep. 22, 2003
(86) PCT No.: PCT/DE03/03141

§ 371 Date: Apr. 11, 2005

(30) Foreign Application Priority Data
Oct. 11, 2002 (DE) 102 47 526.1

(51) Int. Cl. H04B 5/00; G08B 1/00; G08B 21/00

(52) U.S. Cl. 455/41.1; 340/531; 340/686.1

(57) ABSTRACT

Disclosed is an information transmission system comprising a transmitter (1) which capacitively and asymmetrically couples an electric near field into an electrical conductor element (6). Said conductor element (6) is made of an essentially homogeneous medium and is provided with an impedance (CB) to the ground, which is used as a return conductor during the transmission of information. A receiver (4) capacitively decouples the electric field and demodulates the transmitted information. The inventive information transmission system can be used in a tire pressure measuring system of a motor vehicle, for example, the conductor element being part of the body of the motor vehicle.

The invention relates to an information transmission system by means of which information is transmitted from a transmitter to a receiver. It also relates to a transmitter and a receiver for this information transmission system, and to an application of the information transmission system in a tire pressure measuring system of a motor vehicle.

In conventional information transmission systems in which signals are transmitted by radio there is a radio transmitter 20 (FIG. 4) having an antenna 21 via which electromagnetic waves (shown here as a dashed, lightning-like arrow) are emitted. An antenna 22 of a radio receiver 23 receives the electromagnetic waves and extracts the transmitted information from them.

In this case the actual information transmission takes place by electromagnetic radiation in the far field. For this purpose, each antenna 21, 22 must be matched to the frequency of the radiated electromagnetic fields. Otherwise there is a serious degradation in the quality of the information transmission.

Such a radio transmission in the high-frequency range has the disadvantage that it requires expensive materials and components such as antennas 21, 22, HF transmit and receive units, control unit, baseband circuitry etc. The power consumption is very high for such a radio transmission, one reason being the need to compensate for the losses on the transmission link. In addition, electromagnetic waves are also transmitted into an unwanted environment because their amplitude decays only slowly. This means that the information that is transmitted can be easily intercepted or jammed. In addition, interference with other systems occurs, which not only results in poorer reception, but also can have a negative impact on other systems. Furthermore, the number of users of a radio transmission channel is limited.

Information can also be transmitted in the high-frequency range in a known way using line-conducted transmission. To do this, an alternating current is fed to a line having signal conductor and return conductor, the line inductance and the line capacitance affecting the power transmission. The propagation speed is limited in this case. The higher the frequency transmitted, the more complex and expensive the design of the lines needs to be.

The disadvantage with this information transmission is that signal and return conductors are needed that are electrically insulated from their surroundings. Tapping into the conductors degrades the information transmission. Thus the coupling-out points must be specially designed. The signal and return conductors together with their insulation must be adapted to suit the ambient conditions so that no short-circuits are created.

The object of the invention is to create an information transmission system having a transmitter and a receiver that has a simple design, guarantees a reliable information transmission using existing infrastructure, and can be used universally.

This object is achieved by an information transmission system having the features of claim 1, by a transmitter having the features of claim 8 and by a receiver having the features of claim 9.

Said information transmission system comprises a transmitter whose coupling element 2 is used to emit substantially an electric near field. This field is coupled into an infrastructure body comprising an electrically conducting element in which a line-conducted conduction current is then conducted. The conduction current can be coupled out by a receiver comprising a coupling element 2. The circuit is completed via displacement currents which flow across coupling capacitances and ground capacitances of transmitter and receiver and flow back via ground or the conductive floor.

This has the advantage that, owing to the capacitive coupling into the infrastructure body, the losses of a radiating system are avoided, and hence transmitter and receiver have a far lower power consumption. Unwanted stray fields that propagate over long distances are not produced, because the coupling from the transmitter into the infrastructure body takes place by an electric near field having only a short range. Any existing bodies that also comprise elements, at least some of which are electrically conducting, can be used as the infrastructure body. The main losses arise only in coupling capacitances between transmitter/receiver and ground. Small losses will also arise between the coupling elements and infrastructure body should the distances between them become too large.

Further advantages of the information transmission system according to the invention are the displacements of the transmission path from the radiation far field into a quasi-stationary near field with a high-frequency alternating current. In principle this prevents the high-frequency energy being radiated into the surroundings, which otherwise could result in increasing interference in external systems and systems associated with the information transmission system itself. Thus approval by radio authorities is no longer necessary because the interference range and amplitudes can be kept really low. The losses on the transmission path are reduced, and the power consumption can be minimized. No antennas are required because the electromagnetic field to be emitted is coupled into the infrastructure body either directly or capacitively. Thus versatile and mobile use of the information transmission system is possible. Without the need for antennas, the electronic equipment becomes simpler, no special positioning is required for the antenna, allowing the sensor, a control unit and a transmission unit to be implemented on a semiconductor chip.

A signal transmission in the quasi-stationary electric field does not require any timing extraction at the receiver end because the system clock could be fed uniformly into the transmission medium (infrastructure body with its conductor elements). In this information transmission system, radio engineering techniques such as carrier conditioning, modulation, multiplexing techniques, reception and demodulation can be applied without restrictions.

Advantageous embodiments of the invention are described by the features of the sub-claims. One particularly advantageous feature here is the use of existing infrastructure bodies to transmit the information. The medium, i.e. the conducting element of the infrastructure body, does not need to be implemented specially for the purpose. It is enough if the conducting element is electrically conductive, said conductance being time-invariant, so that there is no degradation of the transmission. It is also advantageous if the infrastructure body has an electrical impedance with respect to ground potential, by which means a good return line is then formed via ground in the information transmission. The advantageous use of the frequency band in the range 5 MHz to 50 MHz means that the electronic circuit can be implemented in power-saving CMOS technology.

This information transmission system can be used particularly advantageously in a tire pressure measuring system of a motor vehicle. The motor vehicle bodywork and undercarriage (including wheels with tires) is used here as the infrastructure body. Disposed in each tire is a transmitter which transmits the data/information to be transmitted via the electrically conducting metal undercarriage (wheel rims and wheel axles) and the bodywork to a receiver on the vehicle. In the same way, another wireless information transmission can be implemented from or to sensors and/or actuators in a motor vehicle.

Exemplary embodiments of the invention are described in more detail with reference to the schematic drawing, in which:

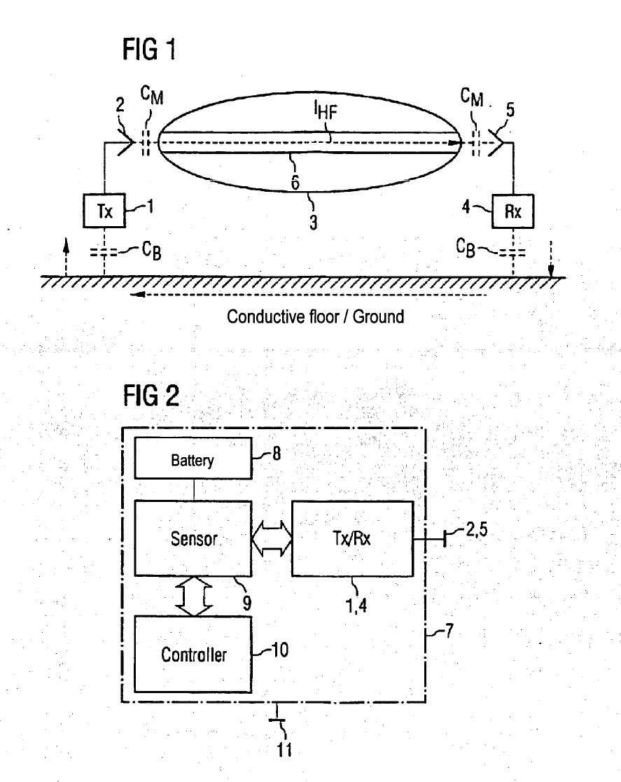

FIG. 1 shows a block diagram of an information transmission system according to the invention,

FIG. 2 shows a block diagram of a transmitter/receiver of the information transmission system as shown in FIG. 1,

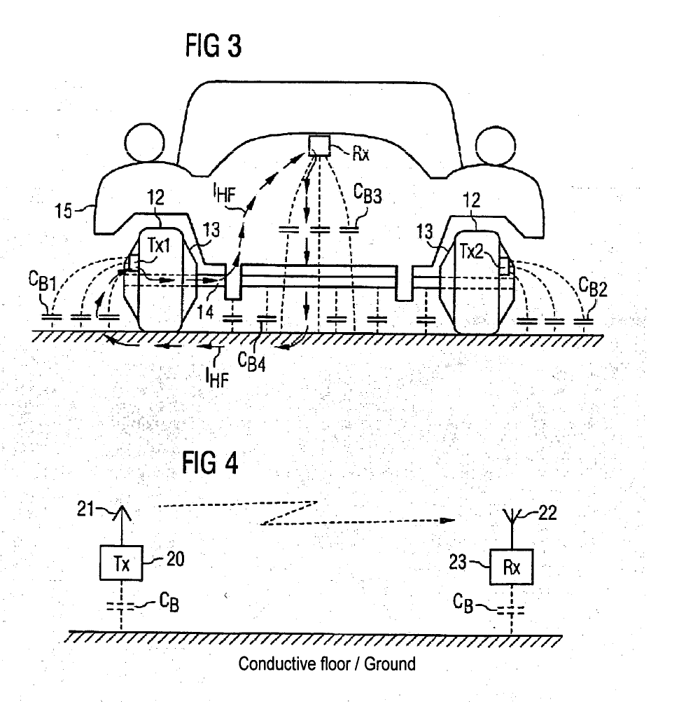

FIG. 3 shows a block diagram of an exemplary embodiment of the information transmission system applied in a tire pressure measuring system of a motor vehicle, and

FIG. 4 shows a block diagram of a conventional radio information transmission system.

An information transmission system according to the invention comprises a transmitter 1 having a transmit element Tx, which generates an electric near field as a stray field via a coupling element 2. A signal current is to be induced in an infrastructure body 3 by means of the electric field, and information (data, messages, signals) transmitted. At the receiver end there is a receiver 4 which also has a coupling element 5 for “receiving” the electric field induced by the signal current.

The infrastructure body 3 is disposed between transmitter 1 and receiver 4, said infrastructure body comprising one or more electrically conducting elements 6 (referred to as conductor element or electrical conductor) that are electrically insulated from ground (ground potential).

Transmitter 1 and receiver 4 each have a capacitance to ground (referred to below as ground capacitance C_{B}).

In order to transmit information, the transmitter 1 generates via its coupling element 2 a quasi-stationary electric near field which impinges on the electrical conductor element of the infrastructure body 3. The gap between the coupling element 2 and the conductor element 6 is bridged by a displacement current which flows via the “virtual” capacitance C_{M} (shown dashed in FIG. 1) between coupling element 2 and conductor element 6. A high-frequency conduction current I_{HF} (dashed arrow in the conductor element 6 in FIG. 1) flows in the electrical conductor element 6, said current generating around the coupling element 5 of the receiver 4 a quasi-stationary electric near field which impinges on the coupling element 5, whereby the transmitted information is received.

The circuit from transmitter 1 to receiver 4 and back is closed at the transmitter end via the coupling capacitance C_{M} between coupling element 2 and conductor element 6 of the infrastructure body 3, by the electrical conductor element 6, at the receive end via the coupling capacitance C_{M} between conductor element 6 and coupling element 5 of the receiver 4, via the coupling capacitance C_{B} between receiver 4 and ground, and back via ground as electrical conductor and the coupling capacitance or ground capacitance C_{B} between ground and transmitter 1. In this circuit, the displacement current known from radio transmission flows via the respective coupling capacitances C_{B}, C_{M}, and a conduction current flows in the conductor element 6 of the infrastructure body 3 and the ground.

Existing infrastructure bodies 3, such as the bodywork of a car, the base plate of a factory machine, a rubberized chain conveyor, turbine blades, metallized product labels, the heating installation in a building etc. can be used as the infrastructure body 3 with its electrical conductor element 6.

Owing to the quasi-stationary electric near field between coupling element 2 and infrastructure body 3, a relatively low power is sufficient to induce a corresponding alternating voltage in the conductor element 6 via the near field. The transmission system is energy-saving and hence exhibits only low losses. The range of the near field is very low, however, so that the coupling elements 2, 5 must each be arranged close to the infrastructure body 3 with its electrical conductor element 6. On the other hand, this has the advantage that the transmitted information can only be intercepted or manipulated with difficulty from a distance, because there is no field propagation in the far field and the amplitude of stray fields decays very rapidly (proportional to 1/r² or 1/r³).

The carrier frequency can be selected so that the impedances of the ground capacitances C_{B} and the coupling capacitances C_{M} between coupling elements 2, 5 and infrastructure body 3 are very low, so that the resultant voltage drop, and consequently the losses, are low. In addition, the coupling capacitances C_{M} between respective coupling element 2, 5 and the infrastructure body 3 depend on the mutual separations and dimensions in the given application (can be calculated in a similar way to the capacitance of a plate capacitor).

The electrical conductor element 6 of the infrastructure body 3 should be made of a substantially homogeneous material and its conductivity should be time-invariant (i.e. not vary over time). The transmission medium for a high-frequency alternating current then exists, constituting a complex RCL network having reproducible conditions. The losses are still substantially lower than in a high-frequency radio channel. The electrical conductor element 6 need not be made of a single piece. Short distances (non-conducting sections) between conducting material again constitute coupling capacitances that can be bridged easily by a displacement current.

The schematic design of a transmitter 1 or receiver 4 is shown in FIG. 2, where the respective transmitter 1 or receiver 4 has an enclosure 7 in which is arranged a transmit element Tx or a receive element Rx respectively. Transmitter 1 and receiver 4 each have independent power sources 8, possible sensors 9 for measuring physical variables, a control unit (controller) 10 and the respective coupling elements 2, 5 and ground coupling elements 11.

A coupling element 2, 5 constituting a capacitive electrode is electrically connected to the transmitter 1 and the receiver 4 respectively. A capacitor can also be used as coupling element 2, 5. A substantially electric near field (stray field) is produced by the coupling element 2, 5 and radiated in the near field range. The coupling elements 2, 5 can also be replaced by a direct connection. The high-frequency conduction current then flows from transmitter 1 via a matching network (not shown) and via the direct connection directly to the conductor element 6 of the infrastructure body 3.

In this case there is a matching network between transmitter 1 and direct connection via which the dispersed near field is coupled into the direct connection, said matching network having, for example, at least one concentrated capacitor.

Transmitter 1 and receiver 4 each have a coupling capacitance to ground (referred to as ground capacitance CB), which is formed by an electrode (also referred to as ground coupling element 11) of the transmitter 1 and the conductive floor as second electrode. In addition, each transmitter 1 and each receiver 4 have at least one coupling element 2, 5 respectively (also referred to as medium coupler), which provides the electrical coupling to the electrical conductor element 6 of the infrastructure body 3.

Sensor signals or data received from the sensor can be modulated onto a high-frequency carrier as data to be transmitted, and can be demodulated, using the control unit 10. Traditional techniques of information transmission such as modulation and demodulation, which are sufficiently known to the person skilled in the art, can be used with such transmitters 1 and receivers 4.

Since a high-frequency conduction current (I_{HF}) flows in the conductor element 6 of infrastructure body 3, the attenuation along the conductor element 6 is far lower than in a comparable radio transmission, in which a displacement current involving higher losses flows. Thus it is sufficient if the electric field is generated with lower power in order to save energy compared with conventional radio technology and yet achieve relatively large ranges for the transmission.

Even if data is transmitted via the infrastructure body 3 in just one direction, a uniform synchronization—as in two-way systems—can still take place by the system clock being fed into the transmission medium. This is why again only a single electrical conductor element 6, i.e. a single electrical connection, is needed between the coupling elements 2, 5. This is then called an unbalanced electrical conductor element 6, which uses the ground potential as the return line. The power is then also fed into the infrastructure body 3 in an unbalanced way.

The information transmission can also be bi-directional, just as in conventional data transmission. A parallel multi-way transmission as known in information technology can also be used.

FIG. 3 shows an exemplary embodiment (example application) of an information transmission system for the application in a tire pressure measuring system of a motor vehicle. A transmitter Tx₁ to Tx₅ respectively is located in each tire 12 of the vehicle (the spare tire can also be fitted with a transmitter TX₅). The tires are connected to the bodywork 15 of the motor vehicle via the electrically conducting wheel rims 13 and the wheel axle 14. Wheel rims 13, wheel axles 14 and bodywork 15 are electrically conducting and constitute the infrastructure body 3 with its conductor element 6.

A central receiver Rx (or a receiver Rxi, each assigned to each wheel) is connected electrically directly or indirectly to the conducting bodywork 15 and disposed in a suitable position on the vehicle. The existing infrastructure bodies 3, 13, 14, 15 with their electrically conducting elements are now used in order to transmit data such as tire pressure, temperature in the tire, identification number of the tire or the like from each transmitter Txᵢ to the receiver Rx (or also in the reverse direction). To do this, each transmitter Txᵢ generates a quasi-stationary electric near field, which is coupled into the wheel rim 13. A conduction current I_{HF} then flows from there via the wheel axle 14 to the bodywork 15. The receiver Rx can then couple out the signals by electrically coupling out the quasi-stationary electric near field in the vicinity of the bodywork 15 and demodulate the data from these signals.

The current then returns back to the transmitter Tx_{1,2} via a displacement current in the quasi-stationary electric near field of the ground capacitances C_{B3} of the receiver Rx to ground, via the conduction current I_{HF} in the ground and via the ground capacitances C_{B1} and C_{B2} respectively of the transmitters Tx_{1,2}. Even if there is no direct electrical connection between wheel rim 13, wheel axle 14 and bodywork 15, the information transmission is not interrupted because these parts exhibit a coupling capacitance between each other that can be bridged easily and without significant losses via a displacement current.

The transmitters Tx₁ and Tx₂ each have ground capacitances C_{B1} and C_{B2} respectively, while the wheel axle 14 as conductor element has an electrical impedance C_{B4} as ground capacitances to ground potential. The receiver has the ground capacitances C_{B3}.

The application in a tire pressure measuring system has the advantage that the transmitted signals are received with substantially constant amplitude, even when the wheel is turning. This is because the signals are transmitted via the respective wheel rim 13 and wheel axles 14 arranged centrally with respect to the wheel rim 13, and always have to travel the same distance. In radio systems, on the other hand, when the wheel is turning the amplitude varies periodically with the wheel speed because the distance and the phase angle between transmitter Tx and receiver Rx vary periodically with the wheel speed.

In such an application, a dedicated information transmission line does not need to be installed between the transmitter Tx and the receiver Rx. The existing infrastructure bodies 3 with their conducting elements 6 are used. Signals from adjacent vehicles are not coupled into the bodywork 15 because they are too far away and thus have no interference effect.

The flowing HF currents (conduction current I_{HF} and displacement current) are concentrated substantially on the conducting parts and thus do not affect other electrical units. Interception of the information is also made more difficult because stray fields have no effect after just a short distance.

Carrier frequencies between 5 MHz and 50 MHz should typically be used for transmission of the information in information transmission systems of the aforesaid kind. Other frequencies can, of course, also be used, depending on the application and the geometrical dimensions.

Other possible applications for the information transmission system are, for example, transmission of sensor signals via the frame of a factory machine, process organization and control functions on a conveyor line comprising metal links, information transfer for foodstuff packaging having metallized and electrically conducting labels, transmission of signals and sensor signals in a motor vehicle, in an aircraft, or in a goods and refrigeration chamber of a heavy goods vehicle or of a (container) ship, wireless signal transmission in a conference room using a conference table having a metal frame across which the conduction currents flow, or transmitting signals in a building via a heater system, for example.

The information transmission system can also be used to replace bus systems. Thus the existing infrastructure can be used instead of needing to install separate bus lines. In transport engineering (railroad traffic), the information transmission system can be used effectively because the tracks can be employed as the conducting medium without the need to install dedicated signal lines. It is sufficient to dispose the transmitters 1 having sensors 9 at suitable points, which sensors transmit the signals over the track to the receiver 4 in the rail vehicle, for example.

The information transmission system can be used well in instrumentation engineering and indeed in those applications in which extreme environmental conditions exist that are detrimental to a radio transmission or the line-conducted transmission. Thus the information transmission system can be used, for example, under high temperatures, in severe interference fields, at high pressures, in an aggressive atmosphere, etc., provided a suitable transmission medium already exists.

The infrastructure body 3 must comprise electrically conducting parts (conductor elements 6) via which the conduction current I_{HF} can flow. The distance between the coupling elements 2, 5 and the electrically conducting medium (conductor elements 6) must not be too big so that a sufficiently large electric field still impinges on the conductor element 6. The conductor element 6 should be made from a substantially homogeneous material that is electrically conductive, said conductance being time-invariant. The human body is only insufficiently suitable for this because it has a high “input impedance” (skin resistance) and a conductance that varies over time and is not homogeneous, i.e. a conductance that depends on many conditions and also does not deliver definitely reproducible results. In addition, it is not possible to make sufficiently good electrical contact with the human body. In this respect the infrastructure body 3 is used as an alternative transmission medium.

Transmitter 1 and receiver 4 can be integrated in a semiconductor chip. Since long antennas matched to the carrier frequency are not needed, transmitter 1 and receiver 4 can be used in confined conditions, even in screened areas. The transmitter 1 can also comprise various (micro) sensors 9 and control processors (control units 10), and hence can be arranged in the immediate location of the physical variables of interest. This has the advantage that not only can the physical variables be measured more accurately and locally, but the distance between sensor 9 and transmitter 1 is short and not subject to interference.

The information transmission system according to the invention does not have the EMC problems present in a radio system, because the stray fields only extend externally over a short range (near field decays as 1/r² or higher powers of r) compared with the far field, which decays at 1/r.

The unbalanced feed and transmission means that material is saved. The “transmission line”, i.e. conductor element 6 does not need to be designed specially but exists already as part of the infrastructure body 3.

1-10. (canceled)

11. An information transmission system, comprising:
a transmitter having at least one transmitter coupling element for emitting primarily an electric near field;
an infrastructure body having an electrically conducting conductor element electrically insulated from ground, wherein the electric field is coupled into said conductor element; and
a receiver having a receiver coupling element for coupling out the electric field transmitted in said conductor element.

12. The information transmission system according to claim 11, wherein said conductor element is connected for directly coupling the electric field into said conductor element.

13. The information transmission system according to claim 11, wherein said conductor element is disposed for coupling the electric field into said conductor element by capacitive coupling.

14. The information transmission system according to claim 11, wherein said conductor element is made of a substantially homogeneous material, and an electrical conductivity of said conductor element is time-invariant.

15. The information transmission system according to claim 11, wherein said conductor element has an electrical impedance with respect to ground potential.

16. The information transmission system according to claim 11, wherein said conductor element is an unbalanced conductor element configured to utilize ground potential as a return line for transmission of information.

17. The information transmission system according to claim 11, wherein the electric field is modulated with information to be transmitted.

18. The information transmission system according to claim 17, wherein a carrier frequency lies approximately between 5 MHz and 50 MHz.

19. A transmitter for transmitting information, comprising a power supply, a modulator, and a coupling element for coupling information to be transmitted into an electrical conductor element by way of an essentially electric near field.

20. A receiver for receiving information, comprising a power supply, a demodulator, and at least one coupling element for coupling out of a conductor element information transmitted via the electrical conductor element by way of a primarily electric near field.

21. In a tire pressure measuring system of a motor vehicle, the information transmission system according to claim 11, wherein said conductor element is a part of the bodywork of the motor vehicle and each tire of the motor vehicle has a transmitter, disposed therein, and an associated receiver is disposed on the vehicle in a vicinity of the conductor element.
